(19) United States
(12) Patent Application Publication
(10) Pub. No.: US 2002/0151327 A1
(43) Pub. Date: Oct. 17, 2002

(54) Program selector and guide system and method

(76) Inventor: David Levitt, Palo Alto, CA (US)

Correspondence Address: GARY CARY WARE & FREIDENRICH LLP, 1755 EMBARCADERO ROAD, PALO ALTO, CA, 94303-3340, US

(21) Appl. No.: 10/027,112

(22) Filed: Dec. 20, 2001

Related U.S. Application Data
(60) Provisional application No. 60/258,115, filed on Dec. 22, 2000.

(51) Int. Cl. H04M 1/00

(52) U.S. Cl. 455/556; 455/566

(57) ABSTRACT

A custom handheld system, or system to adapt a personal mobile computing device, such as a handheld Personal Digital Assistant (PDA) or cellular telephone, to enable a user to enact and review media choices through wireless control of media-playing devices by the handheld device, and to present media directories on its display. Access to information that enables content directory choices, such as TV program schedule items or CD music track titles, is provided through the native Internet, modem, or other network connectivity of the handheld device. The system provides for uniform interfaces for control and content choices on different media player devices, and provides ways to use the limited handheld device's physical button interfaces to enable audio muting and personalized content surfing with one hand, without requiring use of the handheld device's stylus or touch sensitive display screen. The handheld directories may present personalized views of media choices based on a user's past choices, other profile elements, and information from networked and Internet databases.

### RELATED APPLICATION

This application claims priority under 35 USC §§119 and 120 of U.S. Patent Application Serial No. 60/258,115, filed Dec. 22, 2000 and entitled “Program Selector and Guide in Personal Mobile Appliance”.

### FIELD OF THE INVENTION

This invention relates generally to the field of handheld portable devices, and in particular to the use of such devices to enhance interactive program selection by integrating interactive dynamic media directory (e.g., electronic program guide or EPG) and device control (e.g., remote control) functionality into such devices.

### BACKGROUND OF THE INVENTION

Though modern consumers have an increasing range of media choices—typically tens or hundreds of TV program, movie, and music choices—the current generation of equipment and control makes it increasingly difficult to manage them. Most consumer media devices require users either to enter numeric codes to make choices, or to “surf” sequentially through unwanted choices until they find what they want. To enjoy a particular TV program like “The Sopranos”, a user typically must recall or refer to a program schedule and enter a channel number into a TV remote control. The same user, with a multi-CD player holding hundreds of CDs, may never need to handle a CD again—but to access “Beat It” on the “Thriller” CD, that user may have to refer to a written list of those hundreds of CDs and songs and enter Disk#4, Track #5 into a different remote control. The alternative to such numeric control is to surf sequentially through items in a non-optimal order—such as the channel lineup order of a cable TV provider, or the sequence in which CDs and DVDs have been loaded into a multi-disc player.

Such awkward interfaces, large and growing numbers of choices, and limited displays combine to make program selection difficult. As new devices offer consumers more program choices in a variety of media formats (from channels of cable, satellite and over-the-air broadcast television, to large collections of movies on VHS tapes and DVD discs, and songs on radio, CD, and MP3 players, and the growing availability of on-demand and Internet programming and related information), it is becoming even more difficult to manage these ever-increasing program choices with the simple numeric, channel- and surfing-based interfaces found on today's remote control devices.

In the same consumer media context, the growing number of remote control devices, one for each media playback component, makes the media management complexity problem worse. The user may need to find or keep track of separate remote controls for the TV, the cable/satellite box, CD player, radio receiver, DVD player, DVR digital video recorder/player, VCR, camera, and perhaps other devices such amplifiers. In general, these controls operate at the device level (channel, track, disk number or tuning frequency) rather than by directly offering program title information, since the remote control lacks a display. Moreover, the user must learn and know all the remote controls' interfaces, which may be from different manufacturers and have inconsistent designs. “Universal” remote controls aimed at this problem can enable control of multiple media devices from one handheld device, but often are not a total solution: they lack any content directory display, can not be readily upgraded, and generally remain in one room where they have been configured for one set of devices. They are customized to devices in a home or room, not to an individual's media content preferences. Portable and cellular telephones constitute yet another device to carry, find, or lose, with their own numeric interfaces and directories.

Each cable or satellite TV service and broadcast region has its own channel lineup and directory of currently available programs. Cable, satellite, and digital video recording providers typically offer one or more electronic program guides (or EPGs) for reviewing choices. These generally use the TV screen to display current and upcoming program choices. Typically cable TV systems dedicate a video channel to offer a static, scrolling directory that shows just a few choices at a time. Such a guide may require users to wait for several frustrating minutes to learn what is available on a particular channel, as they passively view fragments of the list of choices in a sequence and timing dictated by the cable TV provider. On some digital TV systems, interactive versions of these EPGs run on a tuning device near the television known as a set-top box, using data provided through the cable or satellite TV service, that let the user control some elements of the guide such as scrolling. These set-top based EPGs also show the guide on the TV screen, interrupting or partially occluding the program content itself while selections are made using a remote control. While such sharing of valuable screen real estate might make sense for device configuration (performed infrequently and typically while users are not viewing program content), it makes less sense for user interaction with a media directory such as an EPG, which is often while users are watching program content. In groups, a user reviewing the electronic guide for an upcoming or alternative program will interfere with the other viewers' experience of the current program, as well as their own.

Previous efforts to provide electronic guides to television programs include a variety of Electronic Program Guides (EPGs) and Interactive Program Guides (IPGs), for viewing and selecting program choices with a remote control, which communicates with a television or set-top box by sending infrared signals to change channels and select a new program. In these solutions the television screen is used as the guide display, so the guide partly or completely covers the TV screen, degrading or interrupting any other program viewing, particularly for other viewers who may not be operating the guide. Moreover, these on-screen guides have grown more unwieldy as the number of television channels and choices available via cable or satellite has grown from a few to a few hundred channels. Like a paper guide, a typical EPG requires the user to enter a 2-digit or 3-digit channel number to enact a viewing choice. In contrast, some IPGs allow the user to make a choice by instead navigating an on-screen cursor to the selection using 2 or 4 direction buttons (Up and Down and optionally Left and Right) followed by a Select key, but this can still require 3 or more button presses even after the name of a desired choice appears on the screen.

Some advanced interactive EPGs let users search for programs by category or by name, although entering text using the buttons on a remote control can be difficult and time consuming. Moreover, users typically view or search through a static EPG which, though often configurable display a desired subset of the directory, does not typically take into account the user's past behavior. For example, if a user frequently watches a particular episodic program, few, if any, EPGs would automatically display that program more prominently (e.g., highlighted or moved to the top of a list as its scheduled viewing time approaches) to reflect the fact that the user is more likely to select that program and that selecting it could be made easier.

What is needed is a handheld device that integrates the functionality of a remote control (i.e., an infrared and/or RF emitter) with the intelligence to enable users to navigate a dynamically interactive directory of program content across a variety of media types, utilizing its own display real estate to avoid interfering with the user's viewing experience.

The economics of an intelligent remote control present another problem. The high cost of a display transforms many such devices (such as the “Pronto” highly-customizable touchscreen universal remote from Philips/Marantz) into expensive niche products. A solution to this problem, however, lies in the recognition that many consumers already own a handheld remote-capable device (i.e., one with an IR emitter), albeit from other markets including organizers (such as the highly successful Palm PDA) and cellular telephones (e.g., from Nokia). Millions of users have begun to adopt mobile handheld devices that support connections to the Internet or telephone network. These include cellular telephones, and electronic organizers known as PDAs (Personal Digital Assistants) that support functions such as calendar and schedule, phone and address book, notes, and to-do lists. More functions can be programmed by third parties. Many of these PDAs and phones contain infrared emitters and receivers intended to support IRDA communication between PDAs, such as exchange of business cards or software. Some devices can be fitted with additional hardware for wireless communications and other functionality.

Thus, by adapting existing mobile handheld devices (PDAs, cellular telephones, or other devices with built-in or add-on IR emitters), one could leverage a large existing user base to springboard the market for highly intelligent remote control devices capable of displaying and updating interactive personalized dynamic media directories to facilitate users' selection of program content across a variety of media types. Such devices often already support one or more direct/indirect methods of connecting to personal computers, the telephone network and/or the including the ability to exchange and synchronize information between the handheld device and external databases. For example, the Palm PDA supports both a multi-conductor electronic cradle and IRDA networking for connection to a personal computer, providing access to the computer's RAM and disk memory as well as its Internet connectivity. Users can download software and data from the Internet directly or through a personal computer, and software systems can transfer information from the PDA to personal computers and the Internet.

Software such as OmniRemote from Pacific Neo-Tek (www.pacificneotek.com), for example, enables various PDAs with built-in or add-on infrared emitters to function as remote control devices. It does not, however, contemplate the integration of an EPG. Recent inventions of Allport (U.S. Pat. No. 6,104,334) and Darbee et. al. (U.S. Pat. No. 6,130,726) address these problems using a separate guide display device that is also a remote control, to be held in the lap or the hand. However, numerous technical, cost, convenience, portability, and learning factors have made these solutions too expensive and difficult for consumers to adopt. These solutions incorporate elements such as specialized base stations and radio transmitters and receivers to receive updates of guide data. The user or guide service provider must buy a new hardware device designed specifically for this guide and remote control functionality. Manufacturing costs are high due to the relatively low production volumes and specialized nature of the devices.

Independently, programmable handheld electronic devices such as Personal Digital Assistants (PDAs) for contact and calendar information, and cellular telephones, have become widespread. Elements of PDAs include a variety of methods of network and internet connectivity, a touch sensitive screen display, text entry methods in support of search, power management including rechargeable battery systems, and hardware buttons. An early effort to use a PDA as a remote control, the Eugene Huang's Insight device, required substantial additional hardware to perform its functions. More recently many PDA devices include a programmable infrared transmitter and receiver, which, while intended for short-range data communication with personal computers and other handheld devices, can also be programmed to send infrared signals that control consumer devices such as televisions.

Handheld computers emit beams of infrared at lower power and narrower angles than entertainment remote controls, and do not always place their infrared port in a convenient location and orientation. This can make user training of the device using another household remote control unreliable. Training under the wrong lighting or battery conditions can result in a controller with a range of just 3 feet from the device, too close for comfort in many leisure environments. The user may also be uncertain how exactly to point the device to control a player device. The handheld display may be upside down, making it hard to read text or view other material, when it is oriented for controlling the player, requiring frequent rotations. The user may be pointing the device slightly out of its operating range.

Television and other entertainment consumption tend to be leisure activities. A key aspect of the remote control is the ability to operate it quickly and make changes instantly, without studying or even looking at the device while pressing a button, and to mute or pause playback instantly when silence is needed, for example when fielding a ringing phone. This is incompatible with typical operation of a PDA, whose touch-sensitive screen is ordinarily operated with a separate pen-like handheld stylus, requiring two hands. Users quickly grow dissatisfied if they have to pull out a stylus to mute the television. Moreover, a culture is emerging in which people carry one or more of these devices with them, seeking to make carrying and access to functions simpler and more mobile by limiting the number of them, for example by incorporating the PDA and cell phone into a single device. It is also possible to generate a pie chart on a PDA which permits a more efficient use of the display of the PDA. A Comparative Analysis of Pie Menu Performance By Jack Callahan, Don Hopkins, Mark Weiser, and Ben Shneiderman. Proc. CHr88 conference, Washington D.C.

Thus, it is desirable to provide a program selector and guide in a personal mobile assistant that overcomes the above problems and limitations of current systems and it is to this end that the present invention is directed.

### SUMMARY OF THE INVENTION

The present invention endeavors to solve the problems described above by integrating an interactive dynamic media directory with device control functionality, thereby enhancing a user's ability to interactively select program content via a handheld unit, such as a personal handheld mobile device. The invention contemplates not only custom device embodiments, but also leveraging existing mobile handheld devices such as personal organizers (PDAs) and cellular telephones.

The handheld unit can control other consumer electronic devices (such as televisions, set-top boxes, CD/DVD players, VCRs, digital video recorders, etc) via infrared (IR), radio frequency (RF) or other wired or wireless communication technologies. The unit preferably utilizes its own screen real estate (in addition to optional use of a television or other monitor where appropriate) to display media directories, related content and buttons or other interactive items. It also may include physical keys, dials, and other controls where appropriate. Software and data can be exchanged with the handheld unit via a variety of connectivity methods, including wired cradles connected to personal computers which may be connected to the Internet, as well as various one-way and two-way wireless technologies and protocols (IRDA, RF, 802.11b, Bluetooth, etc). Thus, the unit may exchange data with the Internet directly (via its native Internet connectivity), via a cradle (to an Internet-connected personal computer), as well as via a local or wide area wireless RF connection.

The handheld unit allows a user to review and enact media choices, through wireless control of media-playing devices. The handheld device may present media choices, for example, as text titles, on its display. Connectivity to information that enables content directory choices, such as TV program schedule items or CD music track title directories, is provided through the PDA or phone's native Internet connectivity, such as through a temporary connection to an Internet-connected personal computer or through a local or wide area wireless radio frequency connection.

The system provides uniform interfaces for control and content choices on different playback and communication devices, including audio muting and/or pausing, selection of content from directories, and surfing among elements in a computed list of content items. The system provides ways to use the limited button interfaces of the handheld unit to enable muting and personalized content surfing with one hand, without requiring the unit's stylus or the touch sensitive aspect of its display screen, or requiring the user to look at the screen.

The directories displayed on the handheld unit may present personalized views of media choices based on the user's past choices and other profile elements. The system may use the Internet, personal computers, servers, and aggregated, anonymous, or specific data about other users' choices to present or recommend programs that this user might enjoy. The system may also use the Internet to add data about new devices and content choices such as TV program schedules in other locations, so the mobile device can continue to provide personalized choices and media device control in other locations.

Media directories can be stored on the handheld unit, and can be updated periodically via the unit's various connectivity methods. Such directories can be customized by the user and integrated where desired to personalize the user's experience. They include standard EPG data (widely available from various sources, such as the Tribune Company of Chicago, IL (www.tribune.com), but formatted with a program-driven, rather than channel-driven, focus. These directories also include other media, such as a user's collections of CDs, DVDs, recorded audio and/or video programs, etc. In addition to program titles (e.g., for each song of a CD), other related information (artist, description, reviews, etc) can also be accessed and/or stored (locally or remotely) via the Internet.

These directories are not only interactive (enabling users easily to select a program for immediate or future playback/viewing/recording/reminders/etc), but are also dynamic. The system (whether locally in the handheld unit or via a remote server) can track users' behavior, including the time/frequency of program selection as well as explicit user feedback. Various personalization and collaborative filtering techniques can be employed (locally and/or remotely) to provide program recommendations and otherwise facilitate a user's program selection (e.g., by prioritizing programs within a directory). In this manner, the display may be as simple as a short list of prioritized text titles, enabling program selection with a single touch of a finger. Additional information (e.g., program descriptions as well as pre-stored related content) may of course be accessed as well.

Yet, the system provides uniform interfaces both for control (e.g., browsing media directories) and program selection across a wide variety of media formats and playback and communications devices. Context-sensitive buttons enable functionality such as muting, pausing, selecting program titles and browsing lists of items (among a host of other functions) to be made available via a consistent uniform interface including ways to surf media choices and perform other common functions with one hand.

Not all of the computation and storage need take place at the handheld unit itself. By providing connectivity to local and/or remote personal computers (e.g., Internet servers), the system can also include server software which performs certain tasks, such as collaborative filtering, searching broader collections of programs and related content, and updating media directories and generally exchanging/synchronizing both programs and data. In some embodiments, users can even maintain their own personalized web pages that can be used to personalize the functionality on their handheld unit, including support for multiple locations (e.g., home, hotel, etc), equipment identification (with remote control codes), as well as various personalized directory/content features.

In a typical embodiment, no training of the handheld remote by the user is required. Through means such as menu selection or text entry with completion, a user indicates the brand, model, or other identifying information needed to retrieve appropriate infrared device control code information from a database. Elements of this database may be included with the software in the handheld device or related setup software, and may also be dynamically downloaded and upgraded through the network connection. Software can rotate the screen image as needed so the EPG directory items remain relatively readable while the handheld unit is pointed to a player, without requiring frequent rotations of the device. Displays on the device can indicate the device control parameters, such as digits it is emitting, to help the user understand its ranges of operation, keep the unit synchronized with player devices, and troubleshoot. The user can easily perform frequent operations like muting and surfing among choices with one hand, by pressing a hardware button, and without looking at the device, making it highly competitive with traditional remote controls. The device can set the clock of various devices to its internal clock time using infrared clock controls. The system supports:

easy, one-handed touch operation of common functions with hardware buttons

dynamic configuration of both hardware and on-screen ‘soft’ buttons

installed and/or dynamic online device codes without user training of remote codes

digit display on handheld

rotating the screen image to adapt to IR port orientation

transactions for purchases such as pay per view, streaming, CDs, DVDs, and media players

dynamic, personalized guide that adapts to user behavior and online data

The present invention provides a solution that can be achieved largely or entirely through software running on existing hardware in PDAs and other handheld devices, re-using native device elements originally intended for other purposes. These include:

a display screen suitable for reading text, which may include multi-bit screen and anti-aliased text fonts to support higher density and readability

internet connectivity, whether through standard PDA hardware docking cradle connection to personal computer, modem, wireless 802.11b, Bluetooth, or other connection,

text entry and search methods,

touch screen, including support for direct random access to named programs in one touch, without the multiple Up/Down/Left/Right navigation button presses normally required, as known by to those skilled in the art in IPGs on TV screens

gesture screen, letting users make selections in little space by pressing, moving and releasing at the touch screen with finger or stylus

real-time clock data for software access to the date and time of day

hardware buttons, especially for frequently used operations that may not require the user to look at the screen, such as audio mute and volume controls,

power management, for example through batteries or recharging dock.

The benefits to the user and service provider using the system in accordance with the invention include:

rapid user-directed browsing of a large guide on a screen designed for reading text,

instant access to programs by touch,

larger display at lower cost,

faster learning curve, for example among millions of current users of Palm OS PDAs who know its text entry methods and other operations,

high portability, to any environment the PDA or phone can go - they are designed to fit in a pocket, and our solution requires no specialized base station tying the device to a single home, room, set-top box or TV, and

fewer user devices, since our service may run on a user's current a PDA and/or cellular phone.

A typical PDA or cellular phone may include native elements some of which may be repurposed to support the present invention's functionality. The elements that can be repurposed may include (less common elements appear in brackets), for a PDA, network connectivity, [wireless connectivity], the display, a touch screen, text entry capability, an infrared transmitter, an infrared Receiver for training, [TV Control Transmitter], the hardware buttons, power management features and a clock.

For a cellular phone, the repurposed features may include power management features, network connectivity, wireless connectivity, a display, [a touch screen], text entry capabilities, an infrared transmitter, an infrared receiver for training, [a TV Control Transmitter], hardware buttons and a clock.

### BRIEF DESCRIPTION OF THE DRAWINGS

FIG. 1 is a block diagram illustrating an embodiment of a general architecture of the present invention;

FIG. 1a is a block diagram illustrating a preferred embodiment of the general architecture of the present invention;

FIG. 2 illustrates elements of a program schedule display on the handheld device in one embodiment of the present invention;

FIG. 3 illustrates the system's display on a Palm PDA, including its touch sensitive display and a built-in infrared emitter and sensor, and a row of control buttons;

FIG. 4A illustrates a portion of a program schedule display on the handheld device in one embodiment of the present invention in which the user is browsing the description of one program while another program remains selected and is being viewed on the user's television;

FIG. 4B illustrates a portion of a program schedule display on the handheld device in one embodiment of the present invention in which the user is browsing the description of programs;

FIG. 4C illustrates an example of the user interface of the handheld device in one embodiment of the present invention wherein the handheld device is being used as a remote control;

FIG. 4D illustrates a guide and user interface in a slightly different embodiment, with frequently used operations like volume control assigned to hardware buttons on a Palm PDA;

FIG. 4E indicates detail elements in the user interface for FIG. 4D;

FIG. 5 illustrates a row of general-purpose buttons on the Palm PDA display in one embodiment of the present invention useful in the control of more than one media device;

FIG. 6 is a sample portion of a hierarchical database of entertainment devices and content that can be navigated with one hand from the handheld unit in one embodiment of the present invention; and

FIG. 7 illustrates a portion of a music CD directory offering options to select a CD, purchase a recommended one, dismiss the purchase opportunity, or request additional information.

### DETAILED DESCRIPTION OF A PREFERRED EMBODIMENT

The invention is particularly applicable to a program selector and guide in a personal mobile appliance and it is in this context that the invention will be described. It will be appreciated, however, that the system and method in accordance with the invention has greater utility since it can be implemented using various different technologies. Now, the architecture of the system in accordance with the invention will be described in more detail.

System Architecture

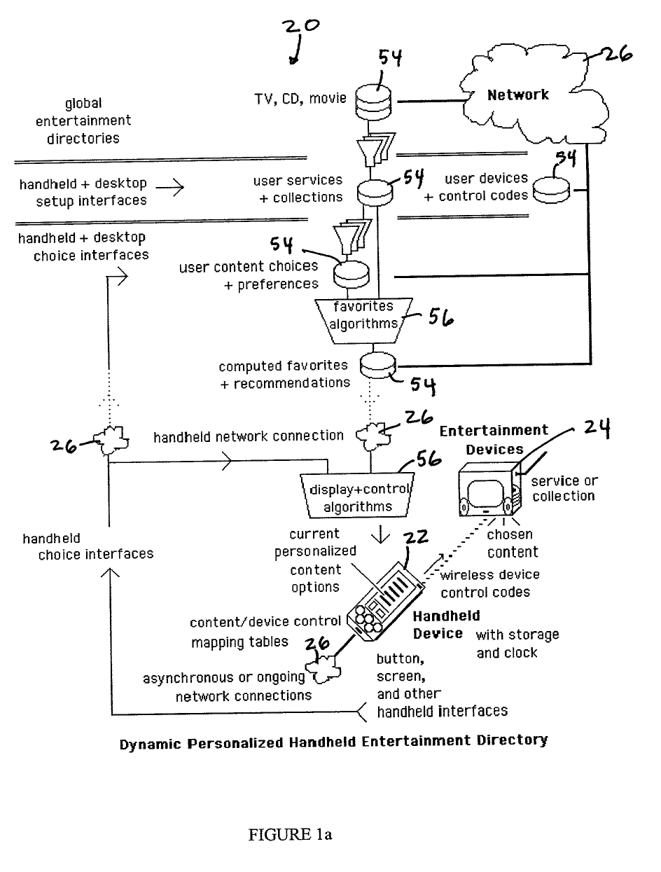

The general architecture of one embodiment of the present invention is illustrated in FIG. 1. As will become apparent, both hardware and software functionality can be allocated among the various components of the system in many different ways. For example, the handheld device can be a custom device, or can be adapted from an existing device such as a Palm PDA (as is illustrated in the various software embodiments for the Palm PDA described below in greater detail). This decision will, of course, also affect the level of integration of the software in the handheld device. Moreover, much of the software and data of the present invention can be embodied not only in the handheld device, but in a personal computer (PC) or Server System, as illustrated in FIG. 1. These decisions will be made as the result of various tradeoffs (whether at a system-wide or application level) involving speed, storage capacity, ease of use and other considerations.

As shown in FIG. 1, the system 20 may include one or more pieces of hardware including a handheld device 22, such as a personal digital assistant in the preferred embodiment, one or more entertainment devices 24 that may be controlled using the handheld device as described below, and a communications network 26, such as the Internet in a preferred embodiment that interconnects the various elements of the system. The system may further include a personal computer 28 that is connected to both the handheld device and the communications network and a cradle 30 that is connected to the handheld device (periodically as is well known), the personal computer, etc. as shown. The system may further include a server system 32 that is connected to the communications system. The system may further include one or more global/regional entertainment directories 34. In more detail, the handheld device 22 may further include one or more pieces of well known hardware 36, such as the processor, the storage unit, the clock and the like, a display 38, such as a liquid crystal touchscreen in the embodiment using the Palm PDA and one or more controls 40 that permit the user to interact with the handheld device. The handheld device 22 may further include one or more wireless communication devices 41, such as an infrared (IR) port and a wireless RF modem as shown.

The system may also include one or more pieces of software 50 that are executed by the hardware described above. The actual location of the execution of each piece of software is flexible and may be changed depending on the particular embodiment of the system. The system may include one or more pieces of user interface software 52, one or more databases 54 and one or more software applications/algorithms 56. These different pieces of software will be described in more detail below.

Returning to FIG. 1, a typical room or home will include various Entertainment Devices 24 as illustrated in FIG. 1, including external sources (such as AM/FM radio and broadcast television, whether over-the-air or via cable or satellite, or even from the Internet) as well as internal sources (pre-recorded songs, movies and other audio/video “programs” stored on CDs, DVDs, VCRs, digital video recorders or DVRs, etc). Other information (audio, video, data, control, etc) could be stored (e.g., on a PC or other consumer device, or on a local/Internet server) and made accessible for audio and/or video playback (whether through a standard TV monitor and speakers or other equipment) throughout the home, or even at a remote location.

In one embodiment, these Entertainment Devices are controlled from the Handheld Device 22 via “commands” such as infrared (IR) codes sent from an IR emitter in the Handheld Device. Of course, other communications standards/protocols (e.g., RF) could be used, though IR has become somewhat of a preferred consumer standard. Repeaters could be used to facilitate access to devices not within sufficient physical proximity. The Entertainment Devices could also be controlled manually (or from other sources, such as a PC), though it is desirable for the Handheld Device to be kept aware of the user's program selections and desires, even if via a later update or synchronization session.

The Handheld Device 22 itself includes sufficient intelligence (processing power, storage, software, etc) to be able to facilitate and implement a user's program selections “at the touch of a button.” Various tradeoffs may be made regarding the use of physical buttons, sliders and other controls, as opposed to “soft” controls, e.g., on a touchscreen. In one embodiment, the Palm PDA is used to leverage its already wide availability to both users and developers, as well as its built-in large touchscreen, infrared emitter, PC/cradle synchronization mechanism (and, in some cases, wireless Internet access), and programmable physical buttons and soft controls.

In other embodiments, the Handheld Device could exchange information (through a wired connection or wirelessly via various transmission and communications protocols, such as RF, IR, Bluetooth, 802.11b, etc) with another computer (directly or indirectly through a cradle or other interim device) in the home or on the Internet. Such communication could be asynchronous (e.g., sync on demand by placing the Handheld Device in its cradle, or periodically connecting to the Internet) and/or continuous (e.g., persistent wireless connection directly from the Handheld Device to the Internet).

These various communication scenarios, illustrated in FIG. 1, enable the Handheld Device 22, in addition to sending commands to Entertainment Devices 24 (e.g., to select or record a program), to update its EPGs and other broadcast program directories, and to exchange information with a PC 28 and/or the Server System 32—e.g., to download current recommendations, upload recent program selections, and update/synchronize personal preferences, content databases, equipment configuration and control codes. In a typical embodiment, a user could maintain a personalized “My Programming” web site (e.g., on the Server System 32) which tracked information relating, for example, to the user's equipment/configuration, program subscriptions, content libraries and personal preferences.

If a user, for example, purchased a new CD or subscribed to a new DirecTV channel, the user could enter that fact into the Handheld Device 22 or PC 28 or Server System 32 (e.g., via a well known browser application, such as Netscape Navigator, that has a well known browser interface). The information could be synchronized continuously or asynchronously (e.g., periodically between the PC and the Server System, and upon demand between the PC and the Handheld Device via the cradle), so that the user would not need to enter the information again. If the user purchased the CD or channel through a transaction on the handheld service itself, product information could be transferred to the Handheld Device automatically and making information entry unnecessary in the first place.

Moreover, additional information could be downloaded into the Handheld Device (e.g., from the Internet 26), such as the individual song titles of that CD, along with relevant descriptions or other information. Certain additional information (e.g., the lyrics of each song) could be stored remotely (e.g., on the user's web site) if storage capacity on the Handheld Device was a concern.

With respect to broadcast television schedules (or other scheduled content, such as Internet radio stations, etc.), the information could be stored on the Internet, whether at the Server System or on a separate site dedicated to that purpose (as illustrated in FIG. 1). This information could be global in nature, but could easily be regionalized and/or personalized to the user based upon user profile information (e.g., maintained at the Server System). Such regionalization/personalization could be performed remotely (e.g., to reduce the amount of data sent to the user), or could be performed on the user's PC or Handheld Device.

The Software architecture 50 of the present invention is also illustrated in FIG. 1. In a typical embodiment, certain portions of the software and data are present on the Handheld Device. Such information could determine the functionality and interface 52 (customizable by the user, locally or remotely) for the setup process, for the display of content directories, soft buttons and other controls, as well as for the manner of transmission of device codes and their mapping (individually and in sequence) to particular devices and content. Note that, if more than one user is present in the household, the system could be configured for multiple users (though some mechanism would preferably be present to identify each user while accessing the device if only a manual selection by the user upon picking up the device).

As discussed in greater detail below, the interface of the Handheld Device is designed generally to simplify the user's task of browsing through program content choices, and selecting them for viewing and/or recording. For example, in one embodiment which relies on the Palm PDA with its built-in IR emitter (which has a narrower range than would a custom remote control device), the interface can be customized to facilitate “one-hand operation” so as to minimize the user's need to look at the display while making selections. For example, having caused the Handheld Device to generate a list of “favorite” songs on a CD, the user might want to browse through that list, hearing each song for a few seconds. By enabling a physical button to perform that browsing function, the user can easily point the device and press that button (whether once for automatic “seeking” of each favorite song in order, or once for each transition to the next favorite song) without having to look back at the screen (as might be necessary, for example, if the user had to touch each song title on the screen).

A user might configure the system to prioritize certain program content or types of content for display on the Handheld Device. In addition to this static personalization, the Handheld Device might adjust these priorities dynamically. For example, if the user had a preference for the show, “Seinfeld” (e.g., because the user expressly indicated that preference, or simply watched the show frequently), the Handheld Device software might recognize that an episode of Seinfeld would be broadcast shortly, and move the title of that program toward the top of the list of available programs. Similarly, if a movie (e.g., “Rain Man”) were already present in the user's DVD collection, and available at the touch of a button via the user's CD/DVD changer, the Handheld Device might recognize this fact and demote the item to a lower position on the list.

As will be illustrated in greater detail below, the interface of the Handheld Device is focused on displaying program content choices for the user, prioritized dynamically in a manner that emphasizes those programs which are most likely to be selected. The software that makes such determination can reside locally on the Handheld Device as well as on the user's PC or, for example, on the Server System. Certain explicit user preferences (e.g., an indication that the user wants to watch Rain Man if it ever is broadcast), might be implemented on the Server System and tagged within the EPG information itself, such that the Handheld Device need merely move such tagged items toward the top of the display. Implicit behavioral information (e.g., noting that the user watches Seinfeld frequently) could also be treated in a similar manner.

Moreover, the Handheld Device itself might make certain other decisions dynamically. For example, the user might, for the first time, indicate an explicit preference for the movie, Rain Man, on the Handheld Device (e.g., by entering its title manually or selecting it upon finding it in the current EPG). Once that movie is about to be broadcast, the Handheld Device could then move it toward the top of the list of program content choices displayed for the user. Various algorithms for prioritizing the program content (distinguishing explicit preferences, implicit preferences, recommendations, etc) can be present on the Handheld Device (or a PC) as well as on the Server System, which would of course have access to additional information on the Internet (e.g., for making collaborative recommendations).

As illustrated in FIG. 1, a variety of information relating specifically to the user and generally to program content and user behavior is stored in various databases 54. These databases can be configured as a single database, or as multiple independent or related databases, and can exist in a central location or be distributed and/or replicated throughout multiple locations. Moreover, certain information may only be stored on the Handheld Device, or on the Server System or the user's PC, while other information may be stored in multiple locations (e.g., the Server System and the Handheld Device, as well as the user's PC).

These databases could include the user's profile information (e.g., name, address, age, etc) and the user's Entertainment Devices and associated device codes, as well as a mapping of device code sequences for accessing specific content or functions. In addition, the user's programming subscription information (e.g., particular DirecTV channel subscriptions) and content libraries (e.g., CDs and DVDs owned by the user, as well as related information obtained, for example, via the Internet, such as song titles and lyrics) could be stored in these databases. Some of this information is relatively static (e.g., user profile information), while other information may be updated frequently (e.g., EPG data).

The Handheld Device, of course, includes client software 56 to manage the functionality and user interface for a variety of tasks including the setup process, the display, navigation and browsing of media directories, the selection of program content, and communication with Entertainment Devices (e.g., emitting sequences of IR commands) and external systems (e.g., the Server System and the user's PC, whether via a cradle or other direct or indirect wired or wireless connection). In the case of a custom device, the Handheld Device would also include an operating system supporting screen management, infrared and other device communications, and a host of other standard “high-end remote control” operating system functions (i.e., a subset of the functionality of the Palm OS).

The Server System (and, perhaps to some extent, the Handheld Device) would include algorithms 56 for prioritizing program content within various media directories, ultimately enabling the Handheld Device to display programs in some prioritized order. Such priorities could be based upon explicit and implicit behavioral user preferences, as described in greater detail below. In addition, a favorites/recommendation engine could provide the user (e.g., via the user interface of the Handheld Device) with recommended program choices, based not only on the user's individual explicit and implicit preferences, but also on those of other users and related third-party information.

As noted above, publicly available EPG data could be formatted, regionalized and personalized for the user (e.g., on the Server System). The Server System could then filter and tag the EPG data it sends to the user (e.g., to the user's PC for synchronization with the Handheld Device), so that the Handheld Device could interpret prioritized tags and display selected programs as higher-priority items.

The Server System also could include algorithms 56 to search the Internet for additional information related, for example, to particular program content. For example, if a user purchases a CD, the Server System could search for the related “CD cover” information as well as individual song titles and lyrics. This information could then either be accessed on demand (during an asynchronous or continuous connection) or downloaded to and stored in the Handheld Device for instant access upon demand.

Many additional embodiments and features of the present invention are described in greater detail below.

System Setup

Setup and maintenance can be performed on the handheld unit itself, or on a desktop computer or Internet browser or other networked client software with access to the system's online databases. The setup system may ask the user to allow it to connect to and perform synchronization operations with a networked device.

In general, setup interfaces present the user with options and support for:

Selection from menus

Text entry and completion as in other organizer search applications

Dynamic menus based on personal profile, as well as explicit and implicit behavioral preferences

Dynamic storage footprint management for handheld unit

System setup may also require payment by the user. Payment may include setup fees, fees for each device or service controlled through the system, and monthly service billing. Free service may be available for a limited time, or indefinitely. The user may be asked to provide a credit card or debit card and secret PIN number or equivalent for authorization. The user may be asked to keep the PIN secret and to provide it when making a pay transaction.

Setup: User Provided Profile Information

Profile information can be provided primarily by user selection in menus offering lists of device brands and TV services, or can be entered as text. The following is profile information that may be provided during set-up.

Handheld Unit Profile Information:

Model information requested but not required.

Brand not required if user will be training device.

Maps remote control Button identifiers onto corresponding infrared transmissions

TV Device Profile Information:

Brand and optional Model

For sending send Power, Volume and other TV function

Receiver Device Profile Information:

Brand and optional Model

To send digits 0-9, Enter and other receiver functions.

Receiver may be the tuner built in to the above TV.

Location Profile Information:

City and State

Zip Code

Both recommended, neither required.

Limits set of broadcast channels and set of TV service providers

Distinguishes different lineups offered by national cable/satellite providers e.g. different AT&T Broadband locales, satellites with different sets of local channels

TV Service Profile Information: Cable/Satellite Company and Tier

Kind, Provider, Tier

Kind: broadcast, satellite, cable

Provider: broadcast, AT&T Broadband, DirecTV, . . .

Tier: analog, expanded basic, digital,

User Profile Information:

Name or other identifier

Optional, but valuable for personalized settings if there are multiple users of this device

Receiving Device Setup and Maintenance

In one embodiment, the handheld device controls a plurality of receiving devices external to it, each enabled for some kind of native wireless control. In other embodiments, the handheld device itself may display the media content directly, such as music through its speakers or video on its own screen. In these cases, some wireless connection and other aspects of the setup process may be unnecessary.

When newly installed, the handheld device's software may include lists of hundreds or thousands of devices to enable selection from menus and automatic text completion. Once service has been established, most of these can be eliminated from the unit's memory, and that storage can be reclaimed for other purposes. The user can also input where necessary information relating to equipment not included in the unit, such as the relevant functions and device codes, and possibly device code sequences to perform certain functions.

Service Setup

The service component determines the appropriate dynamic program guide(s) and the mapping from channels to networks. Together with the guide(s), this determines the mapping from channels and times of day to television programs. The user typically selects a service from one or more menus of national, international, or regional providers such as cable TV or satellite TV companies, or local lists of stations in local broadcast areas. The user may also indicate current channel subscriptions and other details from menus. Moreover, additional services (e.g., Internet radio stations) can easily be added at a later time as desired.

When newly installed, the handheld device's software may include lists of hundreds of cable and satellite TV providers to enable selection from menus and automatic text completion. Once service has been established, most of these can be eliminated from the unit's memory, and that storage can be reclaimed for other purposes.

Collection Setup and Maintenance

Details like favorite artists and genres (whether from explicit requests or implicit behavior) enable the system to obtain and store additional information related to particular content. For example, if a user purchases a new CD, the system may be requested to (or may automatically) obtain related information, such as individual song/track titles, lyrics, artist reviews, and possibly even “CD cover” art. This information may be downloaded to the handheld device and/or stored on the user's PC or the Internet (e.g., the user's personal site on the Server System).

Such services may be available for a fee. Purchases made through this service will automatically update program information.

Handheld Wireless Control of Entertainment Devices

The handheld device controls the receiving devices using a wireless protocol. In one embodiment, the receiving device is designed to receive consumer infrared control signals from its companion wireless remote control, in which case the handheld device emits such signals from its infrared output to emulate the native remote control signals and control the device. Other configurations may include new kinds of receiving devices that support other line-of-sight optical communications such as IrDA, or radio frequency communications such as Bluetooth. New entertainment devices or adapters may support wired or wireless networked control. In general, very low bandwidth is required to select among program choices, as compared to transmitting graphic, audio, or video media.

Each receiving device may have a different set of wireless control sequences or codes. The specific codes needed to control a specific device can be obtained by referring to a database of such device codes, indexed by brand and model, or by training the handheld device using another remote control. Both practices are common in the Universal Remote Control and Trainable Remote Control industries.

Typically the core wireless control codes for tuning or selecting a broadcast program or read-only playback device correspond to the ten decimal digits 0 thru 9 and a Select or Enter key. Other control codes may include volume increase and decrease, mute, pause, and power on/off for the receiving device. In some cases, the native device control system may use spatial selection such as a pop-up menu or two dimensional grid appearing on an entertainment display like a television. In this case browse buttons (up/down/left/right) and Select or Enter are used in the native control scheme. In these cases, the handheld unit's display may indicate the function to the remote control codes being transmitted. Now the setup process will be described in more detail.

During a setup process when first signing up for service, the user indicates the User, Location, TVService, TVDevice, ReceiverDevice if the tuning device is not the TV, and any other devices the user wishes to control. These and related structures are described in Databases/Data Structures below.

The TVDeviceDB and ReceiverDeviceDB databases may be obtained from various sources, including commercial databases of infrared codes for “universal” remote controls licensed in the industry, from public domain sources, or through training by the individual user.

Commercial remote control databases are typically indexed by brand (such as Sony or Philips) from companies such as Universal Electronics or Innotec. Iterative user interaction may help determine which of several devices of the same brand successfully operates the Receiver or TV. Instructions appearing on the handheld device screen or elsewhere during setup may include asking the user “Did the TV turn off?” or “Did the receiver channel change to 2?” to verify that the correct database is being used.

If the handheld device contains an infrared transmitter, the user may train the system through a process that requires pressing each corresponding Button on an existing remote control, such as the device's native remote control, while positioning the PDA so that it can record the remote control's infrared signal for later playback at appropriate times. In the case of user training, the TVDeviceDB, ReceiverDeviceDB and other device databases are constructed through this process, so no reference to a commercial remote control database is required.

Selection from menus and other user interactions during setup may help determine which TV services this user will be controlling. For example, in general there may be more than one cable TV provider and multiple satellite services are available at this Location, with more than one LineUpDB for this Location referred to in the HeadEndsDB. The system may present these to the user during setup, for example by menu, so the user can select theirs. Similarly the user indicate by menu whether they subscribe to an analog basic service, digital cable or other elements of their service, thus indicating the relevant ServiceTier for their TV channel LineUp.

Setup software can be run again later to add users and devices and change locations and services. A typical example is adding another television (and optional receiver) in another room of the same home so it too can be controlled by the service.

At the end of the Setup process the system has effectively computed or selected a LineUpDB, TVControlDB, and ReceiverControlDB for this User based on the profile information the user has entered. This will allow the system to display the channel lineup and to change to a particular station in response to a user command entered, for example, by pressing an on-screen button. Now, the operation of the system will be described in more detail. That operation is also shown in FIG. 1a.

Operation:

Guide Display

For the system to display the guide on the handheld device, the following sequence of steps can be followed. In general, the specific flow of data between computing devices can vary and computation may occur in a combination of a remote server, a local personal computer, the handheld computing device itself, and other networked computing devices, across which parts of the above data may be distributed. The various filtering described can proceed in a different order or on a different processor as long as the same result is achieved.

In some embodiments, the handheld device may obtain information on current and upcoming programs dynamically over a wireless network from a home PC on the same network, through wide area connection through a cellular phone, or other method with little local storage needed. In contrast, in the embodiment described below, the system stores days or weeks of schedule information in advance, which can be updated when the user performs an occasional synchronization operation. Synchronization may be performed using a wired cradle connected to a home PC through Serial or USB connection, wireless infrared data connection to a PC, or a to a network through a modem—all commonly supported in PDA systems—or by various other means.

Server Software

TV listing services such as Tribune Media or ClickTV provide copyrighted program schedule for some time interval, typically for two or more weeks in advance of the program air dates. (Similar data might come instead from online public domain sources.) Such firms provide national and worldwide Head End lists and Channel Lineup information for each tier in each head end, indexed by Location and TV Service providers, as well as TV Schedule and Program listing data. These are the sources of HeadEndsDB, LineUpDB, ScheduleDB and ProgramDB data files used by Server Programs in this embodiment.

Using the Location, TVService and Tier information given in the User's profile, the inventions Server Programs filter large national (or regional or worldwide) databases of stations and programs to include only programs for StationIDs in the LineUp this user can receive.

To store only information relevant to this User in his/her handheld device for an upcoming time interval, such as a day or a week, Server Software refers to each program's ShowStart and ShowDuration further filters the ScheduleDB to include only scheduled programs that overlap with that time interval, which include the date and time of the beginning and end of each program in that database. The Server Software also can filter the ProgramDB, which maps ProgramIDs found in the ScheduleDB onto program names and other descriptive program information, so the filtered version includes only programs referred to in the filtered ScheduleDB, which indicates shows this user can receive over the specified time interval.

The Server Software stores makes available these relevantly filtered ScheduleDB and ProgramDB files, now small enough to be easily installed in the handheld device. Additional data compression can also be performed on by Server Software or PC software, to make files smaller or speed data transfer. These may be decompressed using software in the handheld device.

Viewing Guide Data and Pages

The handheld device contains real-time Clock software that should be set to the correct time. When the user activates the software, the handheld Client Software refers to this clock, comparing the clock's current date and time to the ShowStart and ShowDuration times in filtered and locally stored ScheduleDB.

Ordinarily the user will have access to more programs than can be presented easily on a single screen of the handheld device. Those skilled in the art of PDA design may employ standard solutions to with multiple Pages or generate pages dynamically.

Standard methods for managing multiple pages include a virtual ring or carousel in which each Page has a logical Previous and Next page. Navigation to a Previous or Next page can be achieved by various methods including those described below:

Touch screen button presses

Examples:

button location for transfer to a particular page

on screen button locations for Previous and Next in a structure

Hardware Buttons—for example 2 previous/next buttons

Thumbwheel—for example, as available on Sony CLIE PDAs

clockwise means Next Page, counterclockwise means Previous Page

Touch screen button strokes, pie menus

Text search allows wider access to pages, out of sequence. A user may enter a text string with native device text entry and search by:

Program name

Page name

Genre name

Artist or other personnel name

Touch screen pop-up or pull-down menus also allow out of sequence access to pages, letting the user select a page or category by name.

Pages can be constructed dynamically, for example, presenting shows of one genre or other property indicated in the ProgramDescription data. Now, the database used with the system will be described in more detail.

Databases/Data Structures:

Each of the databases described below contains a set of records with fields as indicated, or their functional equivalents. Records may typically have more fields, including user readable string information and documentation.

Device Databases

ReceiverControlDB

ButtonID, ControlCode

Receiver ButtonID examples include digits: 0, 1, 2, 3, 4, 5, 6, 7, 8, 9, Enter, . . .

TVControlDB

ButtonID, ControlCode

TV ButtonID examples: Power, Mute, VolumeUp, VolumeDown, TV-Video, . . .

ControlCode information may include modulation frequencies for infrared pulses, pulse timing sequences, sampled infrared data, and any other information required to generate infrared or other control signals needed to control the device. TV control is not required to program changing, but is valuable in replacing the most common functions of the TV system remote control within a single handheld system.

Guide Listing Databases

Each database contains multiple records. They may be formatted as indicated:

HeadEndsDB

Location, HeadEndID, LineUpDB

Each record maps a location onto an entire headend and its channel lineups.

LineUpDB:

HeadEndID, ServiceTier, StationID, ChannelNumber

Each record indicates which numbered channel this station is carried on in this headend and service tier. Channels are typically 2-3 digit numbers.

ScheduleDB

StationID, ShowStart, ShowDuration, ProgramID

ProgramDB

ProgramID, ProgramName, ProgramDescription

Structures:

Page

User, Label, Buttons

Button

Page, Rectangle, Channel, ProgramID

The touch sensitive buttons may be implemented as commonly known in the art of PDA software design. Sound feedback can help confirm to the user that an on-screen button has been successfully pressed, or that the handheld device is communicating via infrared. Moreover, Pie Menus can be used to provide additional functions beyond simple button pressing (see reference below) in compact space. When a Page is selected, each Button is drawn in its rectangle, with identifying program or channel information, typically the program title for the program corresponding to ProgramID. When the user viewing the Page presses the button by tapping inside the defined Rectangle, the handheld device can read the corresponding value for Channel in the Button record, and transmits the sequence of ControlCodes (infrared transmissions) that correspond to the ButtonID for each digit in the Channel, most significant digit first. For improved robustness, for some receivers our system may follow the channel digits with an Enter, so if another button is immediately pressed,

Program Selection

The user may indicate a particular program choice through a gesture such as pressing a hardware button, or a soft control on a touchscreen that indicates the name of the program. Users review, choose, or dismiss content choices in any player or service using one simple interface, while preference information is effortlessly collected.

Soft Program Selection Buttons

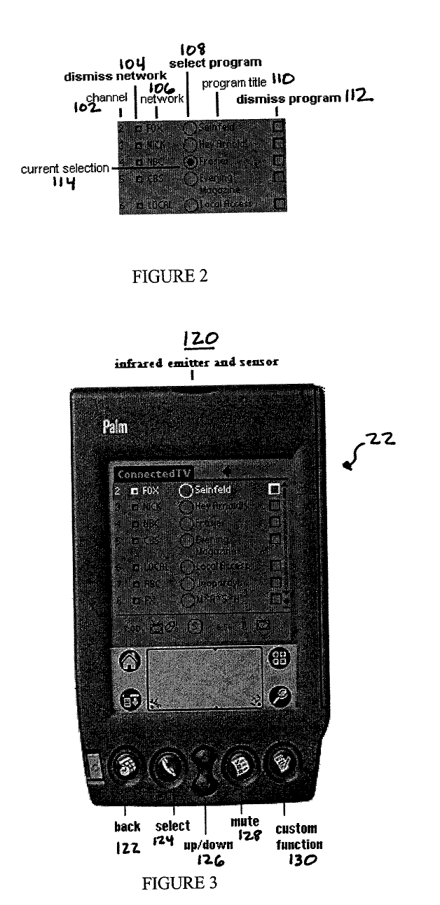

FIG. 2 shows the elements of a program schedule display 100 including programs on 5 networks. The elements may include a channel element 102 that indicates the channel of the particular content being shown, a dismiss channel element 104 wherein the user may remove that channel from the display, a network element 106 that lists the network for the particular content, a select program element 108 that permits the user to select a particular piece of content/program, a program title element 110 that lists the title of each program being displayed, a dismiss program element 112 that permits the user to remove the particular program from the display and a current selection element 114 that indicates the current selection of the user. Bold labels refer to columns of buttons elements. Pressing the circular select button element 108 on the handheld screen surface selects the corresponding program and network and indicates this selection in a history log of this device's behavior. Pressing a square dismiss program button element 112 dismisses the corresponding program or network choice from the list.

Dismissing an element relegates it to a lower position in the current list, or to another list of lower priority. Pressing a dismiss program button 112 dismisses the indicated program and removes the corresponding row from the current screen, moving it to the bottom of the current program list or to another list. If controlling a broadcast receiver device, when that program is over and a new one begins on the same network, the new program may appear on the top of the list depending on its priority. Pressing the dismiss network button 104 removes the corresponding row containing the TV or radio network from the current list (and possibly moves it to another list, depending upon user preferences), independent of which program is playing. The disappearance of the dismissed item leaves room for other programs in the same list, which may scroll automatically to replace it, as well as for parts of other program lists, and other elements.

Optional on-screen elements include pay-per-view options, and other elements such as program and product recommendations, advertisements, and text chat. Pay per view may be enacted entirely through the remote control, including PIN authorization and other information, or the user may be instructed to call the pay per view service provider, or the handheld control may transfer programming and billing information to the service provider later when a network connection has been established, through cooperation with the service provider.

Hard Buttons and Operation with One Hand

While universal remotes typically have 30 or more buttons, the invention allows users to surf favorites and control sound using fewer than 6 buttons on a handheld device, with one hand. Only complex activities, like searching for a program by name, might require the stylus or the touch sensitive aspect of the display screen.

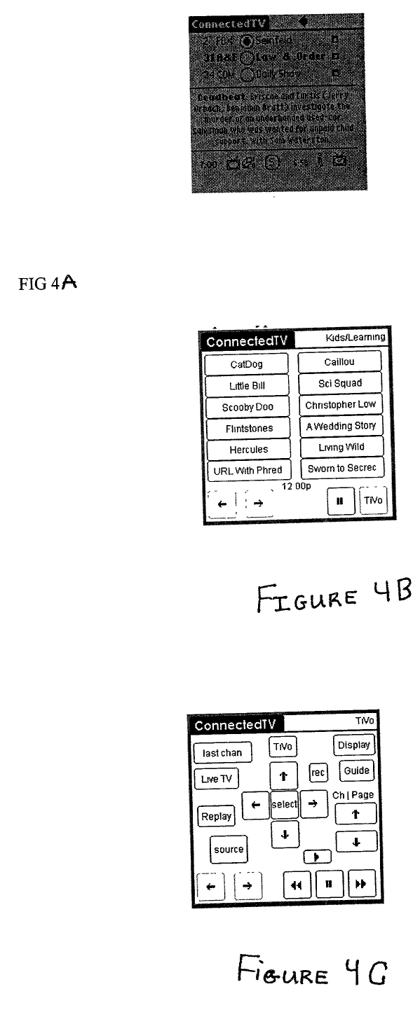

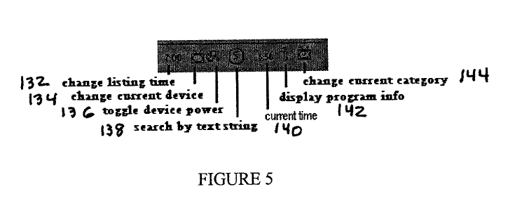

FIG. 3 illustrates the handheld unit 22 and its controls. In this example, the system's display is on a Palm PDA, including its touch sensitive display and a built-in infrared emitter and sensor, a row of hardware control buttons, and several software control buttons (explained below and in FIG. 5). The controls shown in FIGS. 3 and 5 include an infrared emitter and sensor 120 for communications using IR signals, a back button 122, a select button 124, an up/down button 126, a mute button 128 and a custom function button 130. In this example, the typical buttons on the Palm PDA have been reprogrammed. As shown in FIG. 5, the soft buttons (buttons shown on the screen of the Palm PDA that can be selected by touching the touchscreen of the PDA(may include a change listing time button 132 to display the current listing time and to change the current listing times, a change current device button 134 to change the current device being controlled by the handheld unit, a toggle device power button 136 to turn on/off the current device being controlled, such as the television, a search by text string button 138 to search for a text string, a current time button 140 showing the current time, a display program info button 142 to display the programming information and a change current category button 144.

Using the up/down and select buttons, the user can either review programs in a lazy ‘Review’ mode that requires the user to press the select button to tune a new program, or surf in an eager ‘Auto Select’ mode that automatically tunes to each program when the user scrolls to it. An indication of which of these modes is in effect can be displayed on the screen.

In FIG. 3, highlighting indicates that Seinfeld is the program currently being considered. By pressing the select button, the user indicates a desire to tune to the network, channel, and program indicated in that row. The dark circle indicates that the user has made a selection. As each digit of the channel number or other information is emitted from the handheld device, the unit may present, highlight, or otherwise indicate the digit or element on its display, and emit a sound, to help the user know the device is operating and, for example, that the user should continue pointing the emitter at the receiving device. This provides greater robustness to the user interface.

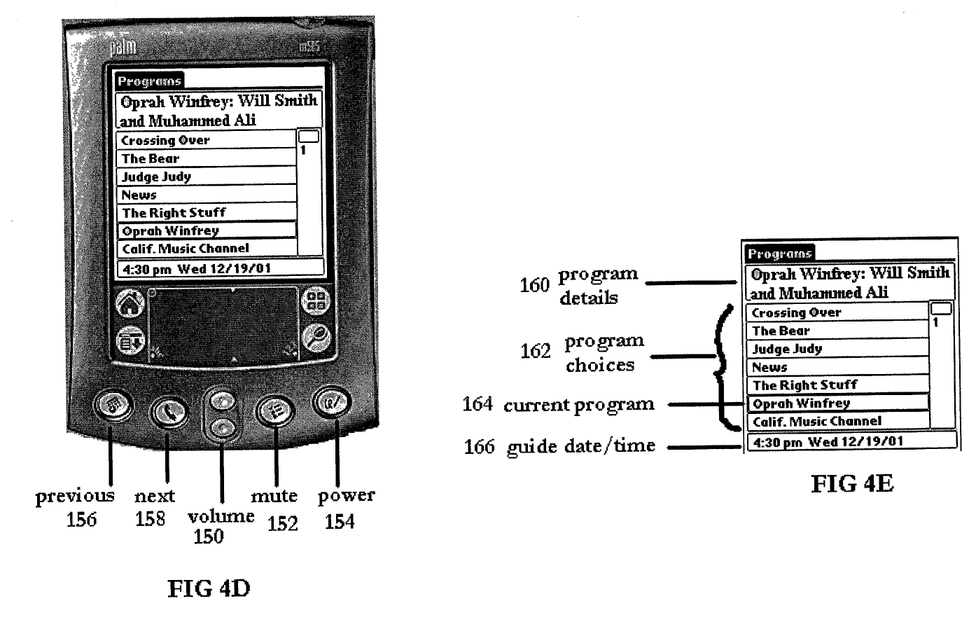

In Review mode, pressing the down button will move the highlight down to the next item. The displayed list may scroll automatically. Information about the currently highlighted program (now shown in bold face) may appear on the screen as in FIG. 4.

FIG. 4B shows a typical screen of the invention. The screen shows a page of currently available program choices from a user's DirecTV satellite TV service, for the time indicated at the bottom of the screen, 12:00 pm or noon, in the Kids/Learning page or category indicated in the upper right corner. Most of the screen is filled with the names of a dozen currently showing programs appearing as labels on on-screen buttons. In this case, programs that were already in progress before the indicated time 12:00 pm time have a small dot preceding the title—in this case, the Flintstones was already in progress. To select a program, the user simply taps the on screen button for that program with a finger or stylus, while pointing the handheld device so its infrared transmitter faces the satellite receiver. The two buttons in the lower left can be pressed to provide access to the previous or next page or category. The Kids/Learning label in the upper right corner is a standard pull-down menu that can also be touched to present a list of other pages including other program categories and devices, for selection by a second tap. Then the page changes and the label in the upper right corner reflects the new current page. The user in the example in FIG. 4B has a TiVo Digital Video Recorder in their satellite receiver, which permits additional functionality such as program Pause, indicated on a button with its standard icon, which can be pressed to pause a live or recorded program. The user can access other TiVo-specific functionality by selecting the TiVo page, whether from the pop-up menu or, in this example, by tapping the button labeled TiVo in the lower right.

In FIG. 4C the user has selected the TiVo page, thus changing the page label and populating the screen with a different set of buttons aimed primarily at device control rather than program selection. The TiVo device is a Digital Video Recorder providing various recording, playback control, and content selection for television, using the television screen as a display. The TiVo page provides access to TiVo functions, including on-screen buttons for recording and playback control using standard icons to represent Record, Play, Rewind, Fast Forward, and Pause. The standard navigation buttons Up, Down, Left, Right, and Select let the user browse and select programs recorded in the TiVo device or to use its built-in program guide, while other buttons provide access to other TiVo functions.

FIGS. 4D and 4E show a somewhat different embodiment of a Palm based interface and program browsing and selection page. As indicated in FIG. 4D, the PDA's hardware buttons have been adapted to allow one-handed operation of frequently used functions, including Volume 150 increase and decrease buttons, Muting 152, and Power 154 on/off, as well as easy access to the Previous 156 and the Next 158 page or category in the listing. As indicated in FIG. 4E, the screen elements include a partial list of programs choices 162 to pick from. With the handheld device pointed at the receiver, if the user taps any of these names on the screen and releases, the digits for the corresponding channel will be transmitted, causing the channel to change and tuning that program. This will also update the dark highlight indicating the current program 164. Details for this program or episode, in this example an episode of the Oprah Winfrey program, may appear in an area for program details 160. In this embodiment, if the user wishes to review program details without changing the channel, the user may push upward on the screen before removing the finger or stylus from the touch screen, a gesture indicating ‘put this program up in the detail area’, so the current program and program details are updated to reflect this choice but the channel does not yet change. After reviewing the program detail, the user can subsequently tune the program by tapping its name either in the program choices or in the program detail area. Thus the user can browse and review choices and details without changing channels, interrupting a current program, or otherwise effecting or interfering with the television screen.

In addition to the Previous 156 and Next 158 buttons in FIG. 4D, in this embodiment the on-screen indicator the current guide date/time 166 in FIG. 4E is also a controller that allows the user to navigate and browse other channels, and programs at other times, again using a gesture rather than a simple touch. Drag left to see shows at a earlier time; drag right to see shows at a later time; drag up or down to see pages or channels higher or lower in the list. This use of gesture, a variant of Pie Menus, can be used throughout the interface to provide further functionality while conserving screen space and the number of screen objects.

Cross-Device and Cross-Media Control Interfaces

Several controls and interfaces can be used independent of which media player or tuning device is being operated, simplifying learning, ease of use, and ongoing operation of the device. The hardware mute button 128 appearing in FIG. 3 will mute the television or pause the current playback device, depending on which device has been selected with the change current device control 134 shown in FIG. 5. Pressing the change current device button 134 pops up a menu of devices for the user to choose on the display; in the figure the icon shows the current playback device is the TV system. The toggle device power button 136 can be used to turn the current device or system on or off. For tuned broadcast media as in a TV listing, the change listings time button 132 shows what time the listed programs will start and lets the user change it with pop-up menus. The search by text string button 138 can be used to perform a text string search. The palmtop device's native text entry system (e.g. designed for memo entry on a PDA or speed dial names in a cellular phone) may be used to enter text for search by program name or other category. The display program info button 142 lets the user view information about the currently highlighted program; in some embodiments, this could be mapped onto a hardware button such as the custom function button 130 in FIG. 3. In FIG. 4 the change current category button 144 can be used to switch from a list of favorite programs to another list, such as premium channels. This too can be a pop-up menu displaying its current value, in this case an icon for “current TV favorites”. A display in FIG. 5 also shows the current local clock time.

Interruption-Free Program Browsing

In general, the handheld unit's program guide(s) let the user review choices without affecting the video or audio on the TV display. This has personal lifestyle value as well as social value: participants can consider and review choices without interfering with or interrupting the program other viewers may be watching. FIG. 4 shows the viewer still tuned to the channel for Seinfeld, as indicated by the black dot on the Select button, reviewing details about the upcoming episode of Law and Order, as indicated by the bold face text.

Browsing and Navigating Content Devices and Internet

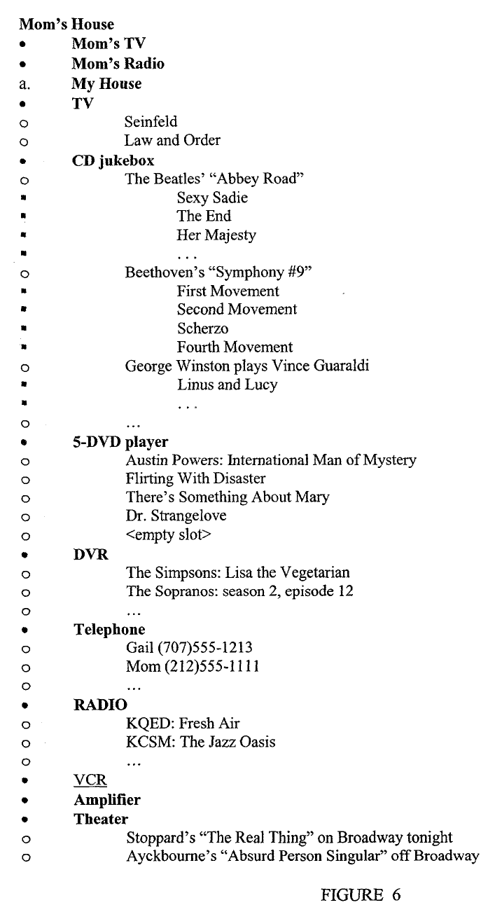

Together with the up/down and select buttons, the back button lets the user browse tree structured databases, including multiple views of program choices available on multiple media playback devices. FIG. 6 shows the core of such a tree that includes multiple homes, multiple devices in each home, and multiple CDs and DVDs in each player, as well as radio and digital video recorder (DVR) programs in devices such as TiVo.

In handheld devices with a thumb wheel in addition to the primary buttons such as the SONY CLIE PalmOS device, the thumb wheel can provide the up/down and select buttons, leaving other buttons available for other tasks.

The same browsing controls can be used to browse Internet web sites, where users can move up and down between consecutive screens or interactive elements, select an item or link, or go back to a previous page using the hard buttons to browse quickly without a stylus, as in a WebTV or AOLTV web experience operated with a remote control. Left and right navigation buttons, either ‘soft’ on the screen or ‘hard’ on physical buttons, may be used to enhance the experience or simplify the layout.

Data Network Connection

The data network connection may be realized in any of several ways, such as:

direct temporary wired connection through a modem

indirect temporary wired connection through another networked device

wireless connection to a wide area network

wireless connection through a local area network.

A wireless network connection may be intermittent, temporary, on demand, or always on. In the case of a PDA handheld, the invention may use the native data synchronization capabilities of the PDA, such as PalmOS HotSync, so that the handheld program schedule is updated when the user performs the synchronization and backup operation for other data, typically by pressing a single button.

Schedule, collection, device, and other system information may be cached on a network device such as a personal computer. Specific methods for maintaining such caches can vary. Systems with intermittent or slow connections may update schedule information eagerly in background and store it on the relatively large personal computer disk, for subsequent access by the handheld device at rates faster than the direct network connection. Systems with high speed always-on connections may limit or eliminate this cache.

In general, a system of coordinated servers or Server System performs computations that use data available from the network and data generated by the user at the handheld, and combines them. Computation and storage may occur on remote servers, on the user's personal computer, Internet gateway, or other device, or on the handheld itself using data provided through the network and server systems.

Upon synchronization of the handheld device with the network, in one embodiment the following sequence of steps updates the handheld device and server system databases to sustain device control and content directory services:

Transfer handheld updates to devices, services, and collection information to server system

Transfer personal selection, dismissal, info request and other behavior and preference information from handheld device to server system

Log changes and resolve inconsistencies between handheld and network databases

Transfer updates to device, service, collection, and preference databases from network databases to handheld as needed

Transfer upcoming broadcast schedule information from network databases to the handheld device

Transfer advertising, targeted marketing queries, transactions opportunities, and related data from network to handheld

Transfer pending transactions, ad responses, and targeted marketing results from handheld to network databases

Transfer performance based marketing data from handheld device to network databases

Profiles: Recording User Behavior and Preferences

Data about the user's decisions and the operation of the device, including selection or dismissal of programs and networks, times and time intervals a program was tuned, user requests for information about programs, and other information can be collected and the forwarded to the server system (and/or to the user's PC). When operating other devices such as multi-CD jukebox players with the device, the system can keeps track of which CDs the user listens to frequently, and which tracks of a particular CD the user listens to first, or repeatedly, and which tracks the user skips. This information, perhaps in combination with other information provided by the user in account setup and maintenance, can be constructed into an entertainment profile of the user's entertainment consumption behavior and preferences.

These user entertainment profiles can be used in a variety of ways that benefit the user of handheld directory services. Also, firms that use, sell, or otherwise value customer and market information may seek access to profile information in various forms and compensate the handheld service provider and/or its users. These parties may include television networks, cable and satellite TV providers, streaming and on-demand media providers, television advertisers, music vendors and artists, and market research firms such as Nielsen and Arbitron rating services, which attempt to sample, measure, and estimate the numbers and demographic attributes of viewers for various entertainment. Information in the user's profile like the user's age, neighborhood, or address may allow demographic and personal information about the user to be hidden for privacy or other reasons, aggregated for statistical purposes, or revealed in greater detail, subject to agreements with users and with parties desiring the information.

Uses of profile information include:

Dynamic Personalized Favorites and Recommendations

Targeted Marketing

Performance Based Marketing

Advertisement and Promotions

Pay Per View and other purchase transactions

Dynamic, Personalized Favorites

The user's entertainment profile can be used for several purposes including construction of dynamic lists of programs in the handheld directory. This provides the user immediate or easier access to preferred and favorite program choices, while offering more difficult access or less screen area to less preferred and least favorite available programs.

For example, if a viewer using the handheld directory to review and tune current broadcast television programs has in the past used the device to select and remain tuned to many episodes of the dramatic series ‘Law and Order’, and ‘Law and Order’ is playing now, the system can elevate ‘Law and Order’ to be higher in the current list of choices. The program can be moved to a list of favorite programs presented to the user before other lists, or toward the top of a list where it will be seen before others. If the user has dismissed a program such as ‘Hey Arnold!’ or the ‘NICK’ network itself, this option can be offered instead on a separate least-favorite programs or networks list, or toward the bottom of a list, where the user might have to scroll to see or select that program choice.

When using the device to tune broadcast TV, the first list presented to the user can be limited to favorites computed through analysis of past tuning (and implied past viewing) and other profile elements. In this context, the buttons that enable surfing, for example through pressing the hard up/down buttons with one hand, will surf first or only among programs computed to be the user's favorites. In one embodiment, “favorites” and recommended programs appear in a separate category, and the user surfs only favorites. In another embodiment, the categories may be linked so that continuing to surf past the end of the favorites list begins to surf favorites in the next category. In another embodiment, items considered the least favorite are stored in separate lists.

While FIG. 3 shows a display the user might see just after setting up the device—showing the networks and programs in order of consecutively increasing channel number—FIG. 2 and FIG. 4 show a shorter list of “favorite” programs the user has watched episodes of before. According to the stored profile, this user has watched many minutes of “Seinfeld” and of “Law and Order” in recent days, and a few minutes of “The Daily Show”. So of currently the available programs, these three are presented first on a short list of favorites, independent of channel number order.

Detailed information in the user's entertainment profile may also indicate, for example, that this is an episode of ‘Law and Order’ the user has apparently seen before, or didn't see the end of, in which case the system can provide ways to offer relevant messages and options to users, more useful lists of choices, and other information that might help the user make program selection decisions. The user may be offered relevant information through the handheld device or other means such as electronic mail, instant messages, displays on a networked device, and online environments.

When the handheld device is used to control a media player such as a CD player or jukebox, dynamic management of favorites may take the form of listing tracks in a different order than they appear on the CD, so songs the user listens to most frequently appear at the top of the list or on a favorites list, while songs the user often skips or never plays appear at the bottom or on a different list. A sequence of tracks or songs might also be presented in the order in which this user most often plays them, or in some other computed preference order, as individual songs in the directory or aggregated in a play list.

Personalized Recommendations

The user's entertainment profile and other elements may be used to provide recommendations of programs and products that may be relevant or valuable to the user. For example, programs may be assigned to categories like “adult comedy” or “police drama” through a human editor or program guide service, providing multiple attributes that support identifying and recommending programs that are similar in one or more dimensions. This information can then be combined with profile information and directory information to help recommend programs the user might enjoy.

For instance, a user who consistently selects episodic adult comedies like “The Larry Sanders Show” and “Sex and the City” may receive a recommendation of a program “Rude Awakening” (when it is broadcast) which also fits the adult comedy category. Thus, “Rude Awakening” might appear on this user's primary list of programs when reviewing broadcast TV choices, for easy selection. The user might also dismiss such a choice. Dismissal of such a recommendation can have immediate effects, such as the removal of this item from a favorites list. It may also effect the user's entertainment profile and have longer term effects, such as placing less weight on adult comedies in future recommendations in this example.

Recommendations may result partly or entirely from profile information provided explicitly by the user. For example, a user may ask the system to include any movie that has Jack Nicholson in its cast on the favorites list when it is showing.

Advertising and Promotion

The screen images that show the user media choices and other information can also show advertisements, marketing and promotional information, and other information. This ad and related information may be particularly suited to the kind of media consumption the user is involved in, such as choosing a broadcast television program to watch. A advertisement paid for by an entertainment vendor such as a television network or production company may indicate a program that is about to begin, which might not otherwise ordinarily appear on this user's short list of recommended programs at this time. In this context, the advertisement would include a button that when pressed allows the user to switch immediately to tuning the advertised program. Presented advertisements and promotions need not be limited to media selections. The screen area can be used to advertise or promote anything, although entertainment programs and devices may be particularly relevant to the context of entertainment choices and devices the user is interacting with. Paid advertisements may be indicated to users and distinguished from other recommendations through differences in typeface, color, or other attributes. Different grades of service may determine whether the user is presented with unsolicited advertisements.

Unlike advertisements on the television screen, advertisements presented through this invention do not interrupt or otherwise interfere with the television program currently being viewed, and can be presented continuously for hours, for as long as the user allows the media directories in the Handheld Device to function. Logs of handheld advertising events can be added to the user's profile and can be forwarded to advertisers, market research firms, and other interested parties. Information about device operation, including hard and soft button control activity, can help indicate whether an ad or other material was seen by the user, and this information too may be forwarded.

Performance Based Marketing

Unlike most forms of advertising, the invention allows some automatic measurement of the effectiveness of an ad by recording, for example, whether the user pressed a button to let the user tune the advertised program. The stored record of button presses may even indicate whether the user continued to watch the program to the end switched to watching something else, and how much time elapsed between such decision events. Records of such user decisions may be forwarded to the directory service provider, advertisers, vendors, and other paying customers, to provide records of the effectiveness of advertisements and promotions, and to provide better recommendations and service in the future. Payments from advertisers may be larger in the presence of such evidence that users actually watched the advertised program.

Targeted Marketing

The system may combine elements of personal profiles and user requests with the business interests of paying advertisers and vendors, in effect helping to find a match between customer and vendor offerings. For example, if the system calculates as above that the program “Rude Awakening” fits the user's preferences, but it appears on a premium network Showtime to which to user has no subscription, the system may present an opportunity to purchase a subscription to the Showtime network programming by pressing an on-screen button, or offer a Pay Per View media consumption opportunity as described below. The provider of the directory service may handle the electronic or other payment, and/or may receive a commission on the subscription or pay per view purchase.

Since the user has no subscription to the Showtime network yet, the appearance of this recommendation may also be predicated on payment of a promotional marketing or advertising fee to the provider of the personal directory service. Different grades of service may offer the user more or fewer recommendations and advertisements in different cost structures.

Pay Per View and Other Purchase Transactions

In some grades of service the user may see in a list a pay-per-view program, a program a premium service this customer does not subscribe to, a product that requires credit card authorization, or some other product that requires a pay transaction. The invention seeks to support these payment modes through cooperation with product vendors, credit card and debit card providers, shipping fulfillment providers, cable and satellite TV providers, pay streaming media providers, and other vendors.

Many purchase transactions can simply be executed through a credit card or debit card. Some purchase transactions may be conducted entirely using the handheld infrared remote control communications with the set-top box, perhaps including authorization through a secret PIN number known to the user, stored in the handheld device or entered for each transaction. Other transactions may require a telephone call or electronic cooperation with the program or TV service provider. Information about the user's requests may be forwarded electronically to the program provider, immediately or upon the next synchronization of the handheld device with the network. Some orders may require synchronization through the network before the program can be viewed or the purchase completed. The handheld directory service provider may automatically receive a commission when such a promotion leads to a subscription, pay-per-view program, or other transaction.

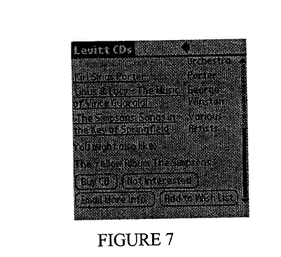

Examples of targeted marketing and purchase transaction opportunities are indicated in FIG. 7. In the figure, a user who has been using the invention to play a CD called “The Simpsons: Songs in the Key of Springfield” is being notified of another album concerning the Simpsons, “The Yellow Album”, not currently in his collection. This may have been calculated using information from the worldwide CD database, indicating “The Simpsons” appears in the title or personnel of only a few different available CDs. The user's choices include:

“Buy CD”, which bills the user and arranges that it be shipped to his home address on his credit card

“Not Interested”, a variant of a dismiss button

“Email more info” sends information to the user's email address to review, perhaps on a PC or handheld device

“Add to Wish List” updates the user's profile to indicate interest in a future purchase or gift. With permission, this wish list may be viewed by peers wishing to purchase a gift for the user.

Any of these choices generally updates the user's profile and performs other operations. Some operations or transaction may not be completed until the Handheld Device has made an online connection.

Cross-Device and Cross-Media Recommendations

The ability to control multiple devices, and to monitor and store records of program browsing and selection activity, lets the system offer recommendations that use information from other services. For example, if a user listens to Bob Dylan CD's every day on her CD jukebox and also uses the Handheld Device to navigate and select broadcast TV programs, the system can recommend or alert the user when a Bob Dylan concert or interview appears in the television schedule. The system can display on screen buttons that easily let the user tune that program on TV easily and immediately.

Directories for Entertainment Venues

This broad and detailed knowledge of the user's viewing experience and tastes can also be applied to other media directories, even those not always subject to handheld control. For example, along with device oriented directories, a user can browse and review customized online directories of currently playing movie, concert, or play choices in accord with the same profile of information gathered about this user's favorite and least favorite artists, performers, writers, genres and shows. A user consulting such a handheld directory may reserve and purchase tickets to the event electronically if this service is available. Some network connectivity is required to complete such transactions.

Whether or not the ticket is purchased electronically, information about the search can remain in the profile to enhance service and recommendations in other media types and devices. A user who searched repeatedly for showtimes of the movie “Jurrasic Park 3” when it was in theaters can be offered a DVD or video copy when that becomes available.

Devices and Directories in Multiple Locations

The user may carry the handheld device to other locations, continuing to control devices and benefit from the personalized directories it manages. To operate devices another location, the user must indicate the type of devices there. For instance, a user with cable TV at home when visiting a distant friend might indicate that the friend has a SONY TV (for volume, power and other controls) and DirecTV service and set-top box (for channel and other controls). From hundreds of channels in an unfamiliar lineup, the user's favorite networks and programs can still appear for easy selection. If the friend has a different selection of premium channels, some programs may not be available, and some new programs and recommendations may be available at this location. The directories show this. The profile and recommendations keep track of viewing at these alternate locations to provide better recommendations and targeted marketing.

Information about multiple alternate device control codes and channel lineups must be available in the handheld device or on the network. As always, trade-offs are possible: a user with a wireless network connection might obtain new device and lineup parameters dynamically; a user without a wireless connection might dock the device to synchronize it with the network information, keep parameters for numerous likely alternative devices and services in a local file, or enter device and service information from a browser on his neighbor's PC. Through agreements with distributors, pay per view and gift subscription services to the alternate location may be provided.

Multiple Profiles and Collaborative Filtering

Networked profiles of multiple users of various services allow the system to compute and present recommendations that benefit from the tastes and past experiences of other users with overlapping interests. For example, the system may combine records of multiple viewers and reach the conclusion that many viewers who watch “Seinfeld” episodes also watch episodes of “Curb Your Enthusiasm”. The system can present this information to users who watch “Seinfeld” in various ways, including providing a message, or moving “Curb Your Enthusiasm” at least tentatively onto a preferred or favorites list in their handheld guide. This is known in the online industry as “collaborative filtering”, and is used widely on line by Amazon and other retailers, for example.

Tuning Broadcast Signals such as UHF/VHF, Satellite TV, Cable TV and AM/FM Radio

The handheld device contains continuously operating internal clock software, including date information. It obtains program schedule information from the data network connection and stores this data into its local memory. Program schedule information for each program includes a program name or other identifier, tuning channel, and explicit or implicit date, start time, end time, and may include other data about the program such as an episode summary or performers' names, information about the program's distributors such as network call letters, and information that the user might find relevant in making program choices. The memory of the handheld device stores a table or equivalent data structure indicating a correspondence of currently scheduled programs and channel numbers or tuning frequencies along with the other information.

Using its computing and memory components, the handheld device compares the current value of its calendar and clock to the day, start time and end time of stored program items. If these indicate a program playing now or starting in some sufficiently small number of minutes, the corresponding program schedule choices are made available as user choices and may be displayed on the handheld screen schedule accordingly.

The time extent of program schedule information stored in the handheld device can vary. In a unit with always-on or inexpensive, responsive on-demand wireless network connectivity, little or no future program schedule information need be stored in advance. In units with temporary network connections, a full future week or more of schedule information may be stored in a single sync operation. The user may also specify the extent of program schedule to store or the amount of memory to allocate for the program schedule(s). The user's past and recent behavior can also be used to determine how much program schedule information to store in the handheld device. For example, a handheld whose user performs a HotSync through a networked personal computer every day need retrieve and store only one or two days of schedule information.

Playing Read-Only Media Such as CD and DVD

Unlike broadcast programs, the directories for active personal read-only collections such as CDs and DVDs change when a user buys, inserts, moves, or removes a read-only content disc from a player device. Users with collections in large carousel and jukebox player devices may particularly benefit, since once inserted a disc need rarely be moved. The list of songs inherent in a particular disk are fixed, but the users playing habits may result in a highly personalized ranking of favorite tracks, discs, and sequences.

The core information for adding a music CD—the name of the CD and the artist—can be collected or entered in a variety of ways to update the system's representation of a user's collection. Purchasing or adding a disc to a personal collection database may involve reviewing menus of choices by artist, genre, title, or other category. If a CD is purchased through transaction using our system—through the handheld device, a PC, Internet browser or other networked client device—the recording, song list, and other information can be gathered automatically from online sources such as CDDB, the Internet CD database in the course of the transaction. Alternatively, the user may select from a menu or type a partial name and enjoy text completion relative to the entries music database, or enter the full CD name. The user may also indicate which slot a disk has been placed in a multi-CD player, or may be asked by the system to use a particular one such as the next consecutive empty one.

With an active online connection, the user has access to hundreds of thousands of CD choices for menu presentation and/or automatic text completion. Text may be entered on handheld device such as a PDA using the native text entry methods for the handheld device.

If a user removes a CD from a player, its profile may remain in the user's collection representation indefinitely or until the user explicitly deletes it; this simplifies data recall when the same CD is re-inserted into the same player or into another device controlled by this user. Depending on memory and network considerations, the title information or detailed information may remain on the handheld device, a PC, or on the network. Titles for likely purchases, such as recordings by a favorite artist, may be cached on the handheld to save the user a network connection or a trip to the docking station.

Players with network connectivity or 2-way wireless connectivity and ability to read digital codes that uniquely identify a disk or recorded program may be used to limit or eliminate the need for user entry of the CD name.

Some multi-disc players support display of the name of a disc or song title, through some effort entering the data manually with the player's remote control. This step be automated when the invention in effect knows which disks are in which slots. The invention can send appropriate remote control codes to the player to label hundreds of CDs or DVDs so the display shows an accurate title instead of just “Disk 23”.

Recording and Playing Local Read/Write Media Such as DVR Programs MP3 Music and VCRs

Recordable media devices such as DVR digital video recorders (including TiVo and Replay TV products) combine elements of broadcast media tuning to initiate or schedule a recording, and read only media playback, described above. Due to the storage capability of the DVR, recording and viewing can be accomplished as separate activities. Moreover, due to the DVR's capability to schedule future recordings, the user can be presented with a more extensive guide showing upcoming programs days or weeks in advance. This larger guide can still be customized to offer priority to program choices that fit the user's profile. For playback, stored media programs can be offered in directories similar to those used for currently scheduled broadcast programs, but without playback time constraints. Program information from recorded programs originating from broadcast sources may be stored on the Handheld Device and/or Server System so, unlike read-only discs, the user need not enter any program information manually.

Similarly, VCRs (video cassette recorders) can be controlled by the invention, to enable and control live recording, scheduled future recording, and playback. The Handheld Device may send codes to set the clock on the VCR, tune channels, and send codes for built-in programmed recording features on the VCR that let it record a program at a future time.

When used to play a stored media program, the hardware buttons, or a set of soft buttons, may be re-mapped to provide transport control and other capabilities. For example, six hardware buttons may be mapped onto the common transport controls Play, Pause (or Toggle Pause/Play state), Stop, Rewind, Fast Forward, and Record. Other digital recorder controls such as Skip or Instant Replay may also be accessed.

The initial setup and ongoing use are somewhat different for each home or system configuration. Some VCRs provide a special ‘cable mouse’ that lets the programmed VCR send IR to the cable or satellite set-top box at the right time. Users of TiVo, Replay TV or UltimateTV disk-based recorders won't be asked to insert a tape.

Likewise, program directories and media itself may originate from the Internet, as is currently commonplace with MP3 music programs traded through services such as Napster. The current invention may control personal computer, specialized device, or other player enabled for wireless or networked control, allowing access to online media directories and media itself. Here again, personal preferences, advertisements, recommendations, and free or pay transaction opportunities are supported in a similar manner and with similar interfaces to broadcast and recorded media scenarios described thus far.

Playing Streamed Media such as Music or Video On Demand

When sufficient bandwidth and infrastructure are available, users may access media that is not locally stored through an Internet connection, networked computer, set-top box, or other device. Similar interfaces for personalized directories, preferences, transactions, and media control can be applied to support such media as may be streamed or cached in a PC, handheld device, or elsewhere in the server system.

Telephone Directories and Communication

Telephone directories can be supported using the same core interfaces that support browsing media directories, in handheld devices supporting telephony, such as cellular telephones, phone-enabled PDAs, and systems of devices such as a linked pair of cellular telephone and PDA. Interface details such as select buttons and recent favorites, dismiss buttons and least favorite lists can be managed using interfaces consistent with the user's media browsing experiences. In the telephone directory device, pressing the select button initiates a telephone call. The consistent interfaces drastically simplify learning and daily use of the interface, preference, and customization schemes.

Media Sharing

Users of more than one handheld devices with sustainable wireless network connectivity can communicate with each other, as well as with media playing devices. Users with access to the same media can agree to share the choices and experiences simultaneously by transferring compact content identifiers from the directories, rather than media samples, from one location to the other. For example, two users on the phone can be ‘disc jockeys’ queuing up CD songs on onto a shared list, using software that synchronizes the lists to play at the same time, or can watch the same program.

Users must grant permissions to allow another user to control their media devices. Program content identifiers are transmitted, typically over one or more wireless connections, from the handheld device through the other user's handheld controller, PC, set-top box, or other media control unit, to the receiving devices.

The system can compute overlap between the users' collections, services, and other entertainment directories, and other aspects of the users' profiles. Non-interruptive interfaces for handheld media browsing described above can facilitate considerate media sharing among users, so they can review choices before changing channels or CDs. A user can review a description of a program on the handheld before attempting to control the other device. With a sufficiently low-latency communications channel, users can jointly browse their directory display using very little bandwidth, or directly surf each others' channels and collections. Common interfaces for telephone call placement and media control on the same device can facilitate talking while sharing media and collaborating in media choices. Some of these activities can occur whether or not the users are engaged in telephone conversations.

### Scenarios

Connected TV: Scenario

Sitting back to relax at 7 after dinner, Jack's son asks “Anything on right now?” and flips on the living room TV. A loud advertisement fills most of the TV Guide channel, while slowly scrolling program info peeks out at the bottom. At this rate, by the time they've seen the 7 PM choices they'll have missed the beginning of everything. Normal.

Then Jack remembers, this afternoon a friend emailed him some free trial Palm software and a note: “Try this with your family tonight. It may not change your life, but I bet it'll change your living room.”

Jack pulls out his Palm and tries ConnectedTV. It lets him select his cable company from a small menu of cable and satellite services. Suddenly he sees listings of dozens of TV programs available to right now. He zips through them all in seconds with the scroll buttons. Ignoring channel numbers, Jack finds he can view current and upcoming programs by category, alphabetically, or in any other order.

Reading a one-line instruction, Jack points his handheld at his cable TV box, taps the name of a promising show, and is instantly tuned to the correct channel.

Next Jack taps a menu labeled Connected VCR. The first screen simply asks:

“Is your VCR flashing 12:00?”

With amused embarrassment, Jack taps the Yes button. The VCR's been flashing ever since his son moved it to another room one evening, a year ago. The handheld unit now asks:

“What brand and model of VCR?”

Jack enters S and O, and Connected VCR completes it: SONY. He chooses the model from a menu.

“Please point your handheld's infrared window directly at your VCR for a few moments.”

Jack obliges, and suddenly the TV is blue and flashing through a barely familiar menu screen. Seconds later the handheld asks:

“Is your VCR now set to the correct date and time?”

Jack looks up and taps Yes again. His son stops and looks. “Way to go, Dad. First time that clock's been right since last century.” Connected VCR has one more question:

“What's your favorite TV program?”

Jack repeats the question to his son. The quick reply: “Simpsons!” By the time Jack has entered “S, I, M, . . . ” he's looking at a highlighted item in a list of episodes of the Simpsons being shown this week. He taps one.

“The Simpsons is showing tomorrow afternoon.

Tap Yes to record this program.

And then:

Don't forget to put in a recordable tape!”

If Jack enables the Remind feature, the following morning his handheld will feep, then:

“Your VCR is set to record The Simpsons today. Don't forget to put in a tape!”

Later that week, Jack is really enjoying ConnectedTV. Now he rarely scrolls through long lists of choices; it's as if the service knows what programs he enjoys and always keeps them near the top of the list. For instance, at 7 PM Seinfeld and Law & Order are at the top, because he watched them both earlier in the week. Other short list items include programs he's lingered on in the past, and movies from his favorite genres that are about to start. When Jack notices a show that doesn't belong on his short list, he taps a “Not Helpful” icon and the program disappears, usually replaced by something he likes better. His current short list is ideal at 7 PM, since he can easily alternate between Seinfeld and Law & Order until he knows which is showing an episode he's missed, or wants to see again. Jay can even check in advance by clicking to read a title or 1 sentence summary of the episode. These summaries don't fill up his Palm device's memory because details are stored only of programs that fit Jack personal entertainment habits and preferences.

Connected TV is for 7+ million current handheld owners with TVs, and 50+ million TV consumers who will buy handhelds in the next few years. In hundreds of millions of homes worldwide, paper and on-screen TV guides have grown unwieldy with choices, while VCRs are so difficult to operate they are usually used for playback only. Connected TV lets viewers easily review what's on now and instantly tune a program, or schedule programs to record on their VCR. It provides a personalized handheld version of the interactive program guide you might expect in an advanced satellite system—but without requiring expensive new hardware or service, and without displacing or shrinking anything on the TV screen.

Connected Music Scenarios

Jay receives two CDs in the mail that he ordered a few days earlier. He inserts the new CDs into two empty slots in his multi-CD player.

A year ago, Jay would have to choose: either spend minutes entering the name of each new CD using digit keys on the player's remote control; or refer to the new CDs as “Disc 17” and “Disc 18” and try to recall their locations, perhaps jotting down the names and slot numbers. Today instead he pulls his Palm device out of his pocket, launches Connected Music, taps on the name of the CD, and points the Palm at his CD player. Jay watches for a few seconds as the name of each CD grows on the player's display, faster and more accurately he would ever enter it with the remote. He taps again and sees the names of the songs on the CD in a list—something even a fancier CD player's display wouldn't show. Jay points his Palm at the CD player once more, taps to choose a song, and in a moment he's hearing the hit he wants most.

This was even easier because Jay bought the CD using Connected Music. The day the CDs shipped, their names appeared in his handheld's Connected Music application, waiting for him to tap them. If he had been given this CD, or bought it on the street, he would enter the CD name once, from his handheld or his PC. Intuitive text completion means Jay rarely has to enter the full name of an artist or CD. The complete CD, artist, and track information are filled in via the Internet.

Connected Music subscriber Mark has just woken up from an unplanned nap. He doesn't know what time it is. He sure doesn't know what CDs are in his player right now. But he knows he wants to hear some Van Morrison.

He pulls his handheld computer out of his jacket and taps on Connected Music. A directory comes up showing the CDs in his player, letting him list every song. Bob enters “V, A, N” into the search field, and every song in his player written or performed by Van appears. If he scrolls down far enough he'll also see a list of the other Van Morrison CDs on his shelf, listed in gray. But not right now. He points his handheld at his CD player and taps Moondance, and moments later he's hearing it.

Mark is using his handheld to browse his CD collection and choose a song. Before, the contents of his 200 CD player used to be hidden inside—but now they're more accessible than ever. At the bottom of the handheld display, the name of a new Van release appears. Mark didn't know the new concert recording was out! When he taps, the next screen offers key info about the CD, and lets him tap among a few options such as “Not Interested” or “Forward More Info,” which would send a link with more details to Marc desktop email account. Since it's a Van album, Mark taps “Add to Wish List”.

Jay and Mark are both subscribers to the Connected Music service. Jay wants to get Mark some music for his upcoming birthday. Mark has given Jay and other buddies permission to view Mark's current list of personal CDs on line. By tapping “Gift”, Jay can see Mark's current collection, browse reviews of music that fits Mark's taste in artists, and highlight items that are in Jay's own collection but not in Mark's yet. The gift decision is simplified when Jay notices the new Van recording in Mark's Wish List. Jay taps in his PIN code, glad he claimed this particular Wish List item before Mark's other buddies got to it. Before Jay confirms, he's offered a one-time chance to get that new Van recording himself at a discount while buying the gift.

Conduit or wireless connection to the Internet CD database lets users review and select songs by name on the handheld, rather than by disk number/track number. The system gradually learns the user's entire CD/DVD collection and lets users track CDs across players and locations if they choose.

A primary market for Connected Music is consumers with CD players and collections especially units that hold multiple CDs—who are current handheld owners or new consumer handheld purchasers. Most consumers have many more CDs than their player can hold, but the many low cost, large capacity multi-CD players are unmanageable without a directory. Even the popular 5-CD models become difficult to manage when one must access a song as ‘CD 3, Track 11’. Connected Music lets users see every CD and song sorted by name, artist, length or other metadata, and choose instantly. The service is a no-brainer for handheld owners with players that hold 10 or more CDs.

While the foregoing has been with reference to a particular embodiment of the invention, it will be appreciated by those skilled in the art that changes in this embodiment may be made without departing from the principles and spirit of the invention, the scope of which is defined by the appended claims.

1. A program selector and guide system, comprising:
one or more entertainment devices that provide content to a user;
a handheld unit that controls the operation of the one or more entertainment devices, the handheld unit further comprising means for receiving content directory information from a remote source, means for generating a content directory displayed on a display of the handheld unit that permits the user to select a particular piece of content for a particular entertainment device and means for controlling the particular entertainment device based on the selected piece of content to display the particular piece of content.

2. The system of claim 1, wherein the handheld unit further comprises means for controlling one or more characteristics of the selected entertainment device, wherein the characteristics include one or more of turning the power on/off to the particular entertainment device and muting the particular entertainment device.

3. The system of claim 2, wherein the entertainment devices comprises one or more sources of content including one or more of a television tuner, a satellite receiver, an AM/FM tuner, a CD player, a DVD player, a digital video recorder and a video cassette recorder.

4. The system of claim 1, wherein the content directory remote source further comprises a satellite content schedule, a cable content schedule, a television schedule and one or more user content libraries.

5. The system of claim 1, wherein the entertainment device comprises a CD player and wherein the content directory information comprises the songs on the CDs within the CD player and wherein the user selects a particular song on a particular CD in the CD player using the handheld device.

6. A handheld device, comprising:
means for receiving content directory information from a remote source;
means for generating a content directory displayed on a display of the handheld unit that permits the user to select a particular piece of content for a particular entertainment device; and
means for controlling the particular entertainment device based on the selected piece of content to display the particular piece of content.

7. The handheld unit of claim 1 further comprising means for controlling one or more characteristics of the selected entertainment device, wherein the characteristics include one or more of turning the power on/off to the particular entertainment device and muting the particular entertainment device.

8. The handheld unit of claim 7, wherein the entertainment devices comprises one or more sources of content including one or more of a television tuner, a satellite receiver, an AM/FM tuner, a CD player, a DVD player, a digital video recorder and a video cassette recorder.

9. The handheld unit of claim 6, wherein the content directory remote source further comprises a satellite content schedule, a cable content schedule, a television schedule and one or more user content libraries.

10. The handheld unit of claim 6, wherein the entertainment device comprises a CD player and wherein the content directory information comprises the songs on the CDs within the CD player and wherein the user selects a particular song on a particular CD in the CD player using the handheld device.

11. A method for selecting programs from one or more entertainment devices that provide content to a user, the method comprising:
controlling the operation of the one or more entertainment devices using a handheld device;
the controlling further comprising receiving content directory information from a remote source, generating a content directory displayed on a display of the handheld unit that permits the user to select a particular piece of content for a particular entertainment device and controlling the particular entertainment device based on the selected piece of content to display the particular piece of content.

12. The method of claim 11 further comprising controlling one or more characteristics of the selected entertainment device, wherein the characteristics include one or more of turning the power on/off to the particular entertainment device and muting the particular entertainment device.

13. The method of claim 11, wherein the entertainment devices comprises one or more sources of content including one or more of a television tuner, a satellite receiver, an AM/FM tuner, a CD player, a DVD player, a digital video recorder and a video cassette recorder.

14. The method of claim 11, wherein the content directory remote source further comprises a satellite content schedule, a cable content schedule, a television schedule and one or more user content libraries.

15. The method of claim 11, wherein the entertainment device comprises a CD player and wherein the content directory information comprises the songs on the CDs within the CD player and wherein the user selects a particular song on a particular CD in the CD player using the handheld device.

16. A handheld device being adapted to be used as a program selector and guide and an entertainment device controller, the handheld device comprising:
means for receiving content directory information from a remote source;
means for generating a content directory displayed on a native display of the handheld unit that permits the user to select a particular piece of content for a particular entertainment device using the native controls of the handheld device; and
means for controlling the particular entertainment device using the native communications of the handheld device based on the selected piece of content to display the particular piece of content.

17. The handheld unit of claim 16 further comprising means for controlling one or more characteristics of the selected entertainment device, wherein the characteristics include one or more of turning the power on/off to the particular entertainment device and muting the particular entertainment device.

18. The handheld unit of claim 17, wherein the entertainment devices comprises one or more sources of content including one or more of a television tuner, a satellite receiver, an AM/FM tuner, a CD player, a DVD player, a digital video recorder and a video cassette recorder.

19. The handheld unit of claim 16, wherein the content directory remote source further comprises a satellite content schedule, a cable content schedule, a television schedule and one or more user content libraries.

20. The handheld unit of claim 16, wherein the entertainment device comprises a CD player and wherein the content directory information comprises the songs on the CDs within the CD player and wherein the user selects a particular song on a particular CD in the CD player using the handheld device.

21. The handheld unit of claim 16, wherein the native display of the handheld unit further comprises a touchscreen display.

22. The handheld unit of claim 21, wherein the native controls of the handheld unit further comprise one or more hardware buttons incorporated into the handheld unit that are repurposed in order to select a particular piece of content.

23. The handheld unit of claim 22, wherein the native communications of the handheld unit further comprises an infrared port for generating commands to control the entertainment devices.
